(19) United States
(12) Patent Application Publication
(10) Pub. No.: US 2003/0156281 A1
(43) Pub. Date: Aug. 21, 2003

(54) Calibrator for calibrating a light beam

(76) Inventors: Leonardus Paulus Crezee, Snelrewaard (NL); Erik van Wijngaarden, Hengelo (NL)

Correspondence Address: LARSON & TAYLOR, PLC, 1199 NORTH FAIRFAX STREET, SUITE 900, ALEXANDRIA, VA, 22314, US

(21) Appl. No.: 10/129,628

(22) PCT Filed: Feb. 19, 2002
(86) PCT No.: PCT/NL02/00108

(30) Foreign Application Priority Data
Feb. 19, 2001 (EP) 01200544.3

(51) Int. Cl. G01J 1/10

(52) U.S. Cl. 356/243.1

(57) ABSTRACT

A calibrator for a sorting device, with a conveyor running in the conveying direction T for sorting articles resembling each other, such as well-determined kinds of vegetables or fruits, the calibrator being used for repeatedly testing and calibrating a light beam coming from a test article, resembling, and obtained in the same manner as, the beams obtained when sorting the above articles, comprising: a first holder for a light receiving device, for instance a light fiber end with which the light beam from either an above article or the test article is received and passed from there further to a detection device, and a second holder with the test article placed therein, characterised in that the second holder is movably connected with the first holder between a test position and a rest position, the position of the test article in the test position at least substantially corresponding to the position of an article when sorting, in the test position the light beam being passed along a light guide path successively from the test article through the second holder to the light receiving device, more in particular characterised in that in the test position the light guide path is completed screened from the surroudings. Such a second holder may be slidable or rotatable. Advantageously, when sorting large amounts of articles calibration can be effected without interrupting the sorting.

The present invention relates to a calibrator for a sorting device with a conveyor running in the conveying direction T for sorting articles resembling each other, such as well-determined kinds of vegetables or fruits, the calibrator being used for repeatedly testing and calibrating a light beam coming from a test article, resembling, and obtained in the same manner as, the beams obtained when sorting the above articles, comprising

a first holder for a light receiving device, for instance a light fiber end, with which the light beam from either an above article or the test article is received and passed from there further to a detection device, and

a second holder with the test article placed therein.

Such a device is described in EP 0 959 353, in which the calibrator shown can be used on a sorting line as shown in U.S. Pat. No. 5,726,750 of the same applicant. The test article described in EP 0 959 353 is intended to function as an accurately adjusted reference. Both the route to be followed by the light beam and the concentration of the sugar solution to be traversed are pre-adjusted.

It will be clear from the figures and the description of the devices in the above patent documents that this precision apparatus can only be brought into action on sorting lines if the articles are each placed on specifically designed holders, so as to be guided thereon along the detection device.

In many cases, such accuracy is not required. Moreover, the speed at which the articles can be sorted will thus be substantially limited.

In the branch of industry in which fruit and vegetables are sorted in very large bulk, the sorting speed is an important pre-condition. More in particular, it holds that, unlike for melons for which the above-described devices are often used, the amounts of apples to be sorted require a substantially higher sorting speed than can be realized with the above devices.

To be able to satisfy the above conditions, the present invention provides a calibrator as mentioned above, characterized in that the second holder is movably connected with the first holder between a test position and a rest position, the position of the test article in the test position at least substantially corresponding to the position of an article when sorting, in the test position the light beam being passed along a light guide path successively from the test article through the second holder to the light-receiving device.

A great advantage of this device is that it can be arranged on any sorting line, in other words: the provisions and apparatus for conveying the articles, like the diabolo conveying paths used for the existing machines for sorting fruits, such as apples, can be maintained unaltered.

In a further exemplary embodiment, the calibrator is characterized in that in the test position the light guide path is completely screened from the surroundings. Of great advantage is that the situations of measuring and testing are thus substantially identical.

A special embodiment of the calibrator according to the present invention is characterized in that both holders are cylindrical and close-fittingly rotatable with respect to each other.

A further embodiment is characterized in that the test position corresponds to the position of an article when sorting. This has the great advantage that the measuring position and the test position are now identical.

Another embodiment of the calibrator is characterized in that the second holder is slidably movable in a direction parallel to the conveying direction, the test position being located just above the position corresponding to the position of an article when sorting.

Very advantageously, it is thus ensured that it is not necessary to interrupt the feed of the articles to be sorted to still enable calibration of the device.

A special exemplary embodiment of this slidable second holder is characterized in that the second holder has the form of a rectangular tube, with the test article contained therein at one end, and with only an aperture at the other end for the light beam substantially running vertically from an article to the light receiving device, further characterized in that in the test position the light beam is passed to the test body by means of an optical system.

The invention will be explained below in more detail with reference to four figures, of which

FIG. 1 is a diagrammatic side view of a sorting line with a superjacent calibrator according to the invention in the rest position,

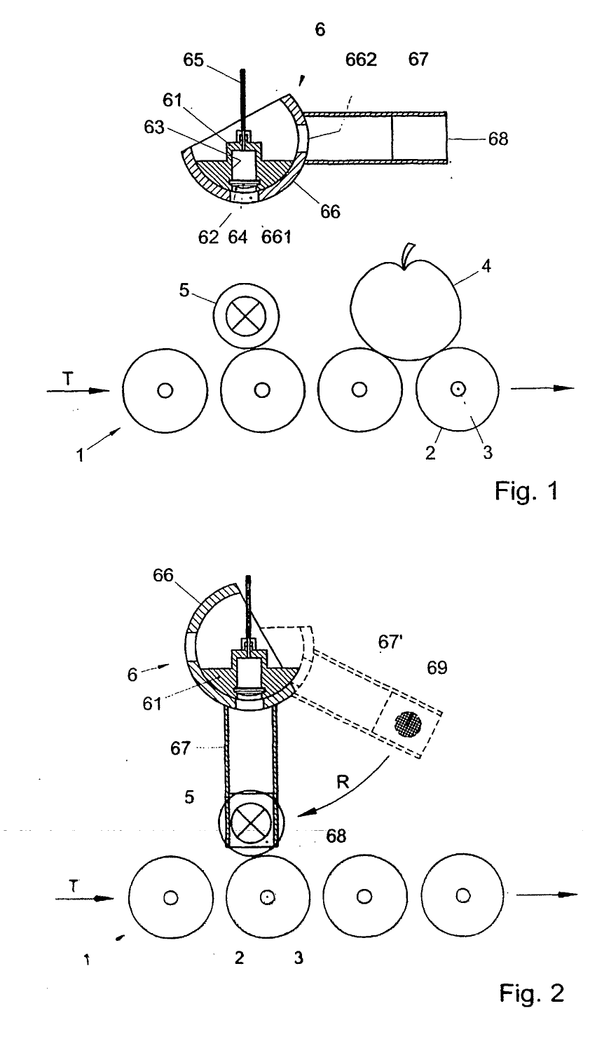

FIG. 2 is a similar view of this calibrator, now in the test position,

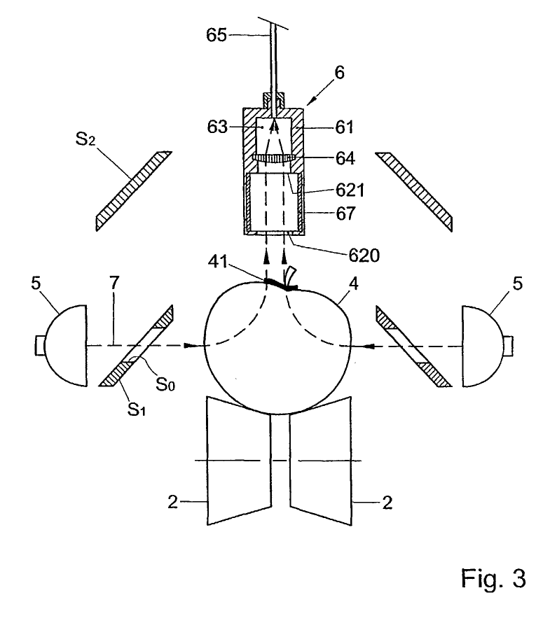

FIG. 3 is a diagrammatic view in the conveying direction of the articles with another exemplary embodiment of the calibrator according to the invention, with the calibrator in the rest position,

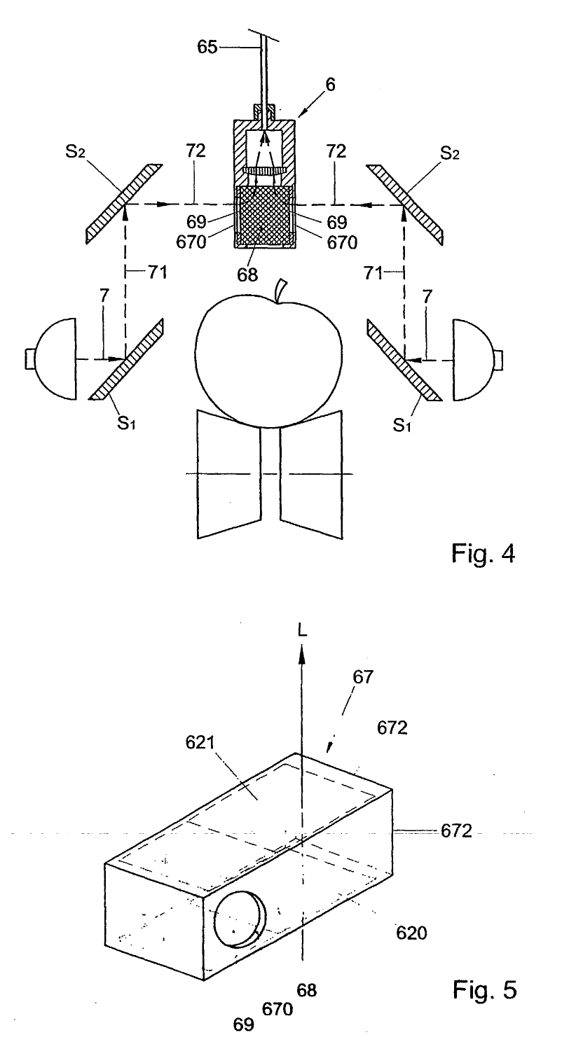

FIG. 4 is a similar view as FIG. 3, now with the calibrator in the test position, and

FIG. 5 is a diagrammatic isometric view of the second holder according to the exemplary embodiment shown in FIGS. 3 and 4.

The same parts of the devices shown in the figures will have the same numerals.

FIG. 1 is a diagrammatic side view of a sorting line 1 conveying articles in the direction of arrow T. The single sorting line 1 shown comprises rollers 2, which are mostly diabolo-shaped and, per two, form a nest for the articles to be conveyed, like the fruits 4 shown here. The view shown is to be seen as taken through the heart of the sorting line, that is to say the middle of the rollers or diabolos. The rollers 2 are coupled with their pins 3, in the known manner, to a conveyor chain or a system of conveyor chains not shown in the figure. Above the sorting line is shown a calibrator 6 according to the invention, here in the rest position in which the articles can freely pass under the calibrator.

To measure through the articles, suitable light sources 5 are arranged beside the conveyor, in principle one on either side of the sorting line, of which one is shown in this view. Light beams thus entering a passing article on both sides will form a light spot at the top of this article, which functions as a source for a light receiving device, also fixedly arranged above the sorting line 1 and in line with the light sources 5.

This light receiving device is incorporated into a first cylindrical holder 61 with, in this embodiment, an entrance aperture 62 in this holder, a, for instance cylindrical, passage 63, and an optical system with a lens 64 and a glass fiber 65. Close-fittingly rotatable around the first holder 61 is a likewise cylindrical second holder 66. In this exemplary embodiment, the second holder has two entrance apertures, a rest aperture 661, and a test aperture 662, corresponding to respectively the rest position and the test position. If desired, several apertures for as many positions may be provided. Connected to the test aperture 662 is a tube 67, with a test article 68 placed therein. This tube 67 may be of square, cylindrical, or also of other cross-section, in accordance with the cross-section of the test article 68.

FIG. 2 shows the test position for the above-described calibrator. A dotted tube 67′ is drawn for a position between the rest position of FIG. 1 and the test position for tube 67 in FIG. 2. To come from the rest position into the test position, the tube must be rotated in the direction of the drawn arrow R. Moreover, in tube 67′ an area 69 is indicated, on one of the sides of the test article, which will correspond to the area where a light beam from one of the light sources 5 will enter the test article. After entering, the beams will form a light spot at the top of the test article 67 in FIG. 2, from where a light beam is passed along a light guide path successively from the test article through the second holder to the receiving device. In the exemplary embodiment shown here, this light guide path is completely screened from the surroundings.

During sorting, the article when passing will be measured through with the calibrator in the rest position, while at intervals, for instance when interrupting the feed of the articles, a test can be carried out with the device in the test position.

With such a test article as reference, it will be possible to reliably observe deviations from the measuring results of the articles and the test results of the test article, that is to say deviations from an expectable average of light intensity to be received. Such deviations will then have to be attributed to light failure of a light source, or to the presence of an entirely different article.

FIG. 3 diagrammatically shows a view of a second exemplary embodiment of the present invention in the conveying direction T with the calibrator in the rest position. Now the second holder 67 is not rotatable in a plane in which the conveying direction is also located, but slidable, likewise parallel to the conveying direction T. FIG. 3 shows how light beams 7 from light sources 5 enter the article 4 on both sides of the sorting line and show a light spot 41 at the top of the article. From there a beam goes to the light receiving device through apertures 620 and 621 in the second holder. The figure further shows in detail how the beams 7 arrive on the article 4 by passing mirrors S1 via a hole therein.

For the exemplary embodiment of FIG. 3, FIG. 4 shows the calibrator in the test position. The second holder 67 is shifted such that the test article 68 is placed before the light receiving device. To cause the beams 7 to enter the test article 68, at least the mirrors S1 are shifted such that the beams are further divided into pieces 71 and 72 by mirrors S1 and S2, and then enter the test article 68 near areas 69 via apertures 670 on both sides of the second holder 67.

For the exemplary embodiments of FIGS. 3 and 4, FIG. 5 shows the second holder 67 in more detail by means of an isometric view. As can be seen, the second holder 67 has the form of a rectangular tube with the test article 68 contained therein at one end, with side walls 671, at least an end wall 672, apertures 670 in both side walls, and an at least partly open upper and lower wall 621 and 620, respectively, to give the light beam coming from an article passage to the light receiving device above it in the substantially vertical direction L.

The great advantage of the exemplary embodiment of FIGS. 3, 4, and 5 is that it is not necessary to interrupt the feed of articles to still enable calibration. The passing articles, if any, can be measured through on such sorting devices via a return program. With the calibrator according to the invention, measurement may even take place between the passages of successive products.

It will be clear to any skilled person that it is advantageous to synchronously shift the mirrors S1 and the second holder 67. It may also be advantageous to adjust the control of the mirrors and the test article such that the lamps can be adjusted each individually before the entry of light to separately determine the response of each. Pertinent means are commonly known.

It has been found that such a test article 68 suitably consists of a block of polymer material, in particular PTFE or polytetrafluoroethylene, with the trade name of Teflon, more in particular PTFE without further filling materials, such as graphite or glass fiber. It will be clear to any skilled worker that other materials or even specifically selected liquids in compartments may be used. The test articles may also be combinations of test articles, including combinations of compartments. Combinations of permeability and spectral sensitivity can thus be compared. Unlike the above-described tubular form, cylindrical form, or block form, the test articles themselves may have other geometric forms to thus obtain a better comparison with the articles to be sorted.

It will be clear to any skilled worker that small variants are also comprised by the main claim and the explanation of the invention. For instance, a combination of a rotatable second holder, shorter than the one explained above, with mirrors S1 and S2, may be used. This will particularly be determined by the available space on such a sorting line. Moreover, for the second exemplary embodiment the synchronous shift of the second holders with both pairs of mirrors S1 and S2 may be considered. Also, the above combinations of test articles or compartments may be measured through in a single run.

1. A calibrator for a sorting device, with a conveyor running in the conveying direction T for sorting articles resembling each other, such as well-determined kinds of vegetables or fruits, the calibrator being used for repeatedly testing and calibrating a light beam coming from a test article, resembling, and obtained in the same manner as, the beams obtained when sorting the above articles, comprising
a first holder for a light receiving device, for instance a light fiber end, with which the light beam from either an above article or the test article is received and passed from there further to a detection device, and
a second holder with the test article placed therein,
characterized in that the second holder is movably connected with the first holder between a test position and a rest position, the position of the test article in the test position at least substantially corresponding to the position of an article when sorting, in the test position the light beam being passed along a light guide path successively from the test article through the second holder to the light receiving device.

2. A calibrator according to claim 1,
characterized in that in the test position the light guide path is completed screened from the surroundings.

3. A calibrator according to claim 1 or 2,
characterized in that both holders are cylindrical and close-fittingly rotatable with respect to each other.

4. A calibrator according to claim 1, 2, or 3,
characterized in that the test position corresponds to the position of an article when sorting.

5. A calibrator according to claim 1 or 2,
characterized in that the second holder is slidably movable in a direction parallel to the conveying direction, the test position being located just above the position corresponding to the position of an article when sorting.

6. A calibrator according to claim 5,
characterized in that the second holder has the form of a rectangular tube, with the test article contained therein at one end, and with only an aperture at the other end for the light beam substantially running vertically from an article to the light receiving device.

7. A calibrator according to claim 6,
characterized in that in the test position the light beam is passed to the test body by means of an optical system.

8. A calibrator according to any one of the preceding claims,
characterized in that the test article may consist of several separate materials or compartments with materials such as liquids.

9. A calibrator according to any one of the preceding claims,
characterized in that the test article has a suitable and/or adapted geometric shape.
